(19) United States
(12) Patent Application Publication
(10) Pub. No.: US 2026/0147371 A1
(43) Pub. Date: May 28, 2026

(54) REFERENCE VOLTAGE GENERATION CIRCUIT AND METHOD THEREOF

(71) Applicant: Samsung Electronics Co., Ltd., Suwon-si (KR)

(72) Inventors: Jeongil SEO, Suwon-si (KR); Seki KIM, Suwon-si (KR); Takahiro NOMIYAMA, Suwon-si (KR)

(73) Assignee: Samsung Electronics Co., Ltd., Suwon-si (KR)

(21) Appl. No.: 19/235,786

(22) Filed: Jun. 12, 2025

(30) Foreign Application Priority Data
Nov. 22, 2024 (KR) 10-2024-0169002

(51) Int. Cl. G05F 3/26

(52) U.S. Cl. CPC G05F 3/267

(57) ABSTRACT

Disclosed embodiments include a reference voltage generation circuit for a semiconductor device, comprising a first current generator circuit configured to generate a temperature proportional current that increases in proportion to temperature, a second current generator circuit configured to generate a temperature complementary current that decreases in proportion to temperature, and a temperature coefficient compensation circuit configured to adjust a second-order coefficient for temperature by adjusting the temperature proportional current or the temperature complementary current, and combine the temperature proportional current and the temperature complementary current, as adjusted, to generate a reference voltage without the second-order coefficient for temperature, wherein the second-order coefficient for temperature is associated with a non-linear variation of the reference voltage.

### CROSS-REFERENCE TO RELATED APPLICATIONS

This application claims priority under 35 U.S.C. § 119 to Korean Patent Application No. 10-2024-0169002, filed on Nov. 22, 2024, in the Korean Intellectual Property Office, the disclosure of which is incorporated by reference herein in its entirety.

### TECHNICAL FIELD

Embodiments described herein relate to a semiconductor device, and particularly to a reference voltage generation circuit of or for a semiconductor device.

### BACKGROUND

With growth in technology, more components may be integrated per unit area on semiconductor chips. In addition, the performance of semiconductor chips is also accelerating. Due to such advanced integration of components and accelerated performance, the heat (e.g., temperature) generated in semiconductor devices has an increasingly significant impact on, e.g., the stability and accuracy of the devices. In some cases, a reference voltage has been used to account for such changes in temperature. Accordingly, calculating and providing a stable reference voltage may ensure the performance and/or reliability of semiconductor devices, particularly those experiencing high temperatures and/or fluctuations in temperature.

In extant technology, the reference voltage may be generated using a band-gap reference (hereinafter, BGR) circuit. In general, the base-emitter voltage (VBE) of a bipolar junction transistor (BJT) may be used to generate the reference voltage. However, the generated reference voltage generally includes a second-order or higher-order coefficient for temperature and/or a further high-order component that is dependent on the temperature variable. Therefore, the generated reference voltage curve includes a curvature that bends up or down-rather than a reference voltage curve that is linear-based on the temperature of the device. The curvature of the reference voltage curve creates non-linear variations in the reference voltage (or a reference current) based on the temperature, and this curvature may have a significant impact on the reference voltage and thereby the stability, performance, and/or reliability of the device.

### SUMMARY

Embodiments consistent with the present disclosure may provide a reference voltage generator circuit or a reference voltage generation circuit capable of reducing voltage changes due to temperature by eliminating high-order temperature coefficients (e.g., second-order terms and higher-order terms). Embodiments consistent with the present disclosure also may provide a reference voltage generation circuit capable of reducing voltage fluctuations due to temperature while minimizing the number of bipolar junction transistors (BJTs).

According to an embodiment, a reference voltage generation circuit for a semiconductor device may comprise a first current generator circuit configured to generate a temperature proportional current that increases in proportion to temperature, a second current generator circuit operatively coupled to the first current generator circuit and configured to generate a temperature complementary current that decreases as the temperature increases, and a temperature coefficient compensation circuit configured to adjust the temperature proportional current or the temperature complementary current to alter a second-order coefficient for temperature associated with the temperature proportional current or the temperature complementary current, and combine the temperature proportional current and the temperature complementary current, as adjusted, to generate a reference voltage without the second-order coefficient for temperature, the second-order coefficient for temperature being associated with a non-linear variation of the reference voltage.

According to another embodiment, a method for generating a reference voltage of a semiconductor device may comprise generating a temperature proportional current using a base-emitter voltage of a bipolar junction transistor, generating, based on the temperature proportional current, a first temperature complementary current having a first second-order coefficient for temperature and a second temperature complementary current having a second second-order coefficient for temperature, wherein the first and second second-order coefficients have different values, adjusting at least one of the first temperature complementary current or the second temperature complementary current, generating a third temperature complementary current by combining the first temperature complementary current and the second temperature complementary current, as adjusted, adjusting the third temperature complementary current, and generating a reference current by combining the temperature proportional current and the adjusted third temperature complementary current.

According to yet another embodiment, a reference voltage generation circuit for a semiconductor device may comprise a temperature proportional current generator circuit comprising a first bipolar junction transistor and a second bipolar junction transistor, the temperature proportional current generator circuit being configured to generate a temperature proportional current that increases in proportion to a temperature using the first bipolar junction transistor and the second bipolar junction transistor. In some embodiments, the reference voltage generation circuit may further comprise a temperature complementary current generator circuit operatively coupled to the temperature proportional current generator circuit and comprising a third bipolar junction transistor and a fourth bipolar junction transistor, the temperature complementary current generator circuit being configured to supply the temperature proportional current to the third bipolar junction transistor to generate a first temperature complementary current that decreases as the temperature increases, generate an intermediate reference current by combining the temperature proportional current and the first temperature complementary current, and generate a second temperature complementary current by applying the intermediate reference current to the fourth bipolar junction transistor. In some embodiments, the reference voltage generation circuit may further comprise a temperature coefficient compensation circuit operatively coupled to the temperature proportional current generator circuit and the temperature complementary current generator circuit and configured to adjust at least one of the first temperature complementary current or the second temperature complementary current to alter a second-order coefficient for temperature, and combine the first temperature complementary current and the second temperature complementary current, as adjusted, to generate a reference voltage without the second-order coefficient for temperature, the second-order coefficient for temperature being associated with a non-linear variation of the reference voltage.

### BRIEF DESCRIPTION OF THE FIGURES

The above and other objects and features of the present disclosure are described in the detailed description below, through embodiments thereof and with reference to the accompanying drawings.

FIG. 1 is a block diagram illustrating a reference voltage generation circuit consistent with disclosed embodiments.

FIG. 2 is a diagram illustrating a circuit configuration according to an embodiment of the reference voltage generation circuit of FIG. 1.

FIG. 3 is a diagram illustrating an example of a related art reference voltage generator circuit that generates a reference voltage using only a temperature proportional current generator circuit.

FIG. 4 is a graph illustrating an example of a change in a reference voltage based on temperature generated by the related art reference voltage generator circuit of FIG. 3.

FIG. 5 is a diagram illustrating an exemplary operation of a reference voltage generation circuit consistent with disclosed embodiments.

FIG. 6 is a flowchart illustrating a reference voltage generation method consistent with disclosed embodiments.

FIG. 7 is a graph illustrating a reference voltage having a curvature that is compensated by a reference voltage generation circuit consistent with disclosed embodiments.

FIG. 8 is a diagram illustrating another exemplary embodiment of a reference voltage generation circuit consistent with this disclosure.

FIG. 9 is a block diagram illustrating an exemplary system-on-chip (SoC) including a reference voltage generator circuit consistent with disclosed embodiments.

### DETAILED DESCRIPTION

It is to be understood that both the foregoing general description and the following detailed description are exemplary, and it is to be considered that an additional description of the claimed inventive concepts is provided. Reference numerals are indicated in detail in embodiments of the present disclosure, examples of which are indicated in the referenced drawings. Wherever possible, the same reference numbers are used in the description and drawings to refer to the same or like parts.

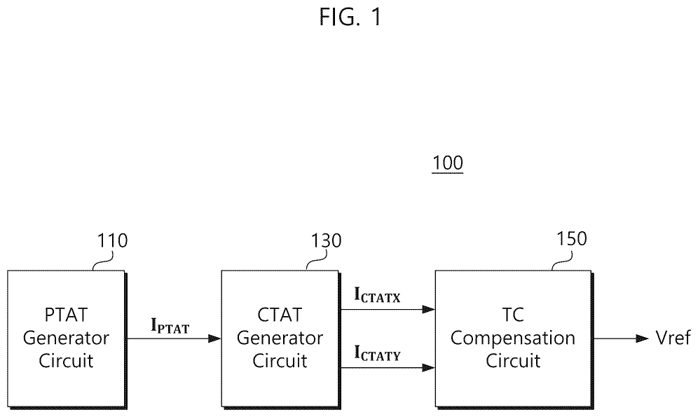

FIG. 1 is a block diagram illustrating a reference voltage generation circuit according to an embodiment of the present disclosure. Referring to the example of FIG. 1, the reference voltage generation circuit 100 may include a PTAT (Proportional-To-Absolute-Temperature) generator circuit 110, a CTAT (Complementary-To-Absolute-Temperature) generator circuit 130, and a temperature coefficient compensation circuit 150. A circuit, as used herein, may refer to the interconnected arrangement of electronic components (such as, e.g., resistors, capacitors, transistors, diodes, and other electrical components) that work together to perform a specific function or series of functions within an electrical or electronic system. Furthermore, any circuit described herein may refer to an individual circuit or to a subcircuit of the disclosed reference voltage generation circuit.

In some embodiments, the PTAT generator circuit 110 may generate a temperature proportional current (I_{PTAT}) that increases with temperature (e.g., that is proportional to a change in temperature). For this purpose, the PTAT generator circuit 110 may include a bipolar junction transistor (BJT) having a base-emitter voltage (VBE). The base-emitter voltage (VBE) of the BJT also has a temperature complementary characteristic (CTAT) that decreases with increasing temperature. The PTAT generator circuit 110 may generate a temperature proportional current (I_{PTAT}) or a temperature proportional voltage (VPTAT) using the base-emitter voltage (VBE) of the BJT.

In some embodiments, the CTAT generator circuit 130 may generate temperature complementary currents (I_{CTATX}, I_{CTATY}) having different temperature factors (‘V_{T} ln(T)’) based on the temperature proportional current (I_{PTAT}) and the base-emitter voltage (VBE) of the BJT. The CTAT generator circuit 130 may apply different collector currents (Ic) to two different BJTs using the temperature proportional current (I_{PTAT}). Then, temperature complementary currents (I_{CTATX}, I_{CTATY}) having different logarithmic errors (‘V_{T} ln(T)’ or ‘Tln(T)’) may be generated. In this example, since the thermal voltage (‘V_{T}’) is expressed as a first-order coefficient for temperature (‘T’), the logarithmic error may be expressed as ‘Tln(T)’.

In some embodiments, the temperature coefficient compensation circuit 150 may generate a reference voltage (Vref) without the error term (e.g., from which the logarithmic error term (‘Tln(T)’) is removed) by using the temperature complementary currents (I_{CTATX}, I_{CTATY}) generated by the CTAT generator circuit 130. The temperature coefficient compensation circuit 150 may adjust the size of the temperature complementary currents (I_{CTATX}, I_{CTATY}) to remove the ‘Tln(T)’ term included in each of the temperature complementary currents (I_{CTATX}, I_{CTATY}). As an example, the temperature coefficient compensation circuit 150 may scale the temperature complementary currents (I_{CTATX}, I_{CTATY}), e.g., by multiplying by a factor of K (wherein K may be an integer or non-integer value). Then, by combining the temperature complementary currents (I_{CTATX}, I_{CTATY}), as adjusted, it is possible to remove the ‘Tln(T)’ value corresponding to the second-order coefficient for temperature. The reference voltage (Vref), from which the ‘Tln(T)’ value is removed, may be generated, e.g., based on the reference current (Iref), from which the ‘Tln(T)’ value is also removed. These features will be described in more detail with reference to the drawings below.

According to the above description, the reference voltage generation circuit 100 consistent with disclosed embodiments may generate a reference voltage (Vref) from which the ‘Tln(T)’ value is removed by, e.g., adding two BJTs to the CTAT generator circuit 130. As a result, it becomes possible to generate a stable reference voltage Vref, even at extreme temperatures, at minimal cost.

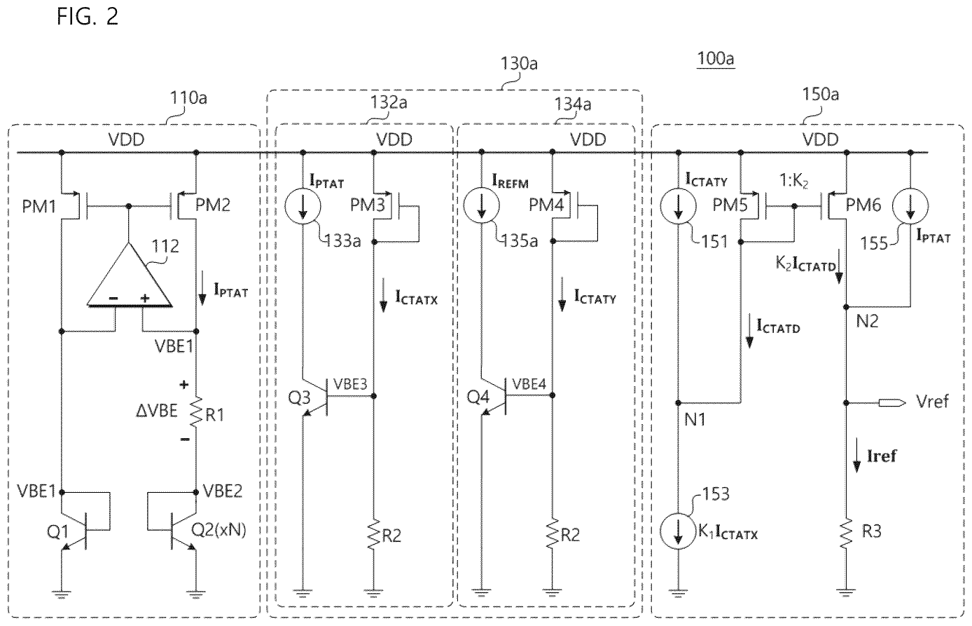

FIG. 2 is a circuit diagram illustrating a circuit configuration according to an embodiment of the reference voltage generation circuit of FIG. 1. Referring to FIG. 2, the exemplary reference voltage generation circuit 100a includes a PTAT generator circuit 110a, a CTAT generator circuit 130a, and a temperature coefficient compensation circuit 150a.

The PTAT generator circuit 110a may include PMOS transistors PM1 and PM2, an operational amplifier 112, a first resistor R1, and bipolar junction transistors (BJTs) Q1 and Q2 to generate a temperature proportional current (I_{PTAT}) that increases according to temperature. The source of each of the PMOS transistors PM1 and PM2 may be connected to a power supply voltage terminal VDD. The gate of each of the PMOS transistors PM1 and PM2 may be connected to an output terminal of the operational amplifier 112. The drain of the PMOS transistor PM1 may be connected to the negative input terminal (−) of the operational amplifier 112, and the drain of the PMOS transistor PM2 may be connected to the positive input terminal (+) of the operational amplifier 112. The collector of the diode-connected first BJT Q1 may be connected to the drain of the PMOS transistor PM1. The emitter of the diode-connected first BJT Q1 may be connected to the ground terminal GND, and the emitter of the diode-connected second BJT Q2 may be connected to the ground terminal GND. The first resistor R1 may be connected between the drain of the PMOS transistor PM2 and the collector of the second BJT Q2. In some embodiments, the second BJT Q2 may comprise any number (xN) of parallel-connected diode-connected BJTs.

With further reference to the exemplary embodiment of FIG. 2, the base-emitter voltage VBE1 of the first BJT Q1 may be input to the negative input terminal (−) of the operational amplifier 112. Then, the base-emitter voltage VBE1 of the first BJT Q1 may be transferred to the positive input terminal (+) of the operational amplifier 112 by the feedback of the operational amplifier 112. Therefore, the differential voltage (ΔVBE=VBE1−VBE2) between the base-emitter voltage VBE1 of the first BJT Q1 and the base-emitter voltage VBE2 of the second BJT Q2 may be applied to the first resistor R1. The base-emitter voltage VBE1 of the first BJT Q1 has a temperature complementary CTAT characteristic that decreases as the temperature increases. On the other hand, a temperature proportional current (I_{PTAT}) having a temperature proportional PTAT characteristic flows through the first resistor R1 by the differential voltage (ΔVBE). Therefore, the basic operation of the PTAT generator circuit 110a may be based on the temperature complementary CTAT characteristic generated by using the base-emitter voltage VBE1 of the first BJT Q1. The PTAT generator circuit 110a may thus generate a temperature proportional current (I_{PTAT}) based on the temperature complementary CTAT characteristic associated with the first BJT Q1.

The CTAT generator circuit 130a may generate a first temperature complementary current (I_{CTATX}) and a second temperature complementary current (I_{CTATY}) by mirroring the temperature proportional current (I_{PTAT}) generated by the PTAT generator circuit 110a. To this end, the CTAT generator circuit 130a may include a first CTAT generator circuit 132a for generating the first temperature complementary current (I_{CTATX}) and a second CTAT generator circuit 134a for generating the second temperature complementary current (I_{CTATY}).

The first CTAT generator circuit 132a may include a PTAT current source 133a, a third BJT Q3, a diode-connected PMOS transistor PM3, and a second resistor R2. A current source, as used herein, may refer to a current mirror circuit (e.g., a circuit configured to copy, adjust, or discharge a reference current while maintaining a consistent current). The PTAT current source 133a may generate a temperature proportional current (I_{PTAT}) having the same magnitude as the current generated from the PTAT generator circuit 110a. The PTAT current source 133a supplying the temperature proportional current (I_{PTAT}) may be implemented, e.g., by mirroring the temperature proportional current (I_{PTAT}) generated from the PTAT generator circuit 110a. The temperature proportional current (I_{PTAT}) may be delivered to a collector of the third BJT Q3. An emitter of the third BJT Q3 may be connected to ground, and a base of the third BJT Q3 may be connected to a node between a drain of the diode-connected PMOS transistor PM3 and the second resistor R2. Therefore, the base-emitter voltage VBE3 of the third BJT Q3, through which the temperature proportional current (I_{PTAT}) flows in the forward direction, may be applied to the second resistor R2. The first temperature complementary current (I_{CTATX}) including the ‘Tln(T)’ value, which corresponds to the logarithmic error for temperature, may thereby flow to the second resistor R2 based on the emitted base-emitter voltage VBE3. The components of the first temperature complementary current (I_{CTATX}) are explained in more detail below.

The second CTAT generator circuit 134a may include a temperature-invariant current source 135a, the fourth BJT Q4, a diode-connected PMOS transistor PM4, and a second resistor R2. In this example, the second resistor R2 of the second CTAT generator circuit 134a may refer to a resistor having the same resistance value as the second resistor R2 of the first CTAT generator circuit 132a. The temperature-invariant current source 135a may be generated, for example, by combining the temperature proportional current (I_{PTAT}) generated from the PTAT generator circuit 110a and the first temperature complementary current (I_{CTATX}) generated from the first CTAT generator circuit 132a. Thus, by combining the temperature proportional characteristic of the temperature proportional current (I_{PTAT}) and the temperature complementary characteristic of the first temperature complementary current (I_{CTATX}), a flattened intermediate reference current (I_{REFM}) may be generated.

A temperature-invariant current source 135a may supply an intermediate reference current (I_{REFM}), which may be generated by a combination of currents and/or implemented through current mirroring. The intermediate reference current (I_{REFM}) may be stable with respect to temperature changes and may be delivered to the collector of the fourth BJT Q4. The emitter of the fourth BJT Q4 may be connected to ground, and the base of the fourth BJT Q4 may be connected to a node between the drain of a diode-connected PMOS transistor PM4 and the second resistor R2. Therefore, the base-emitter voltage VBE4 of the fourth BJT Q4 through which the intermediate reference current (I_{REFM}) flows may be applied to the second resistor R2.

The second temperature complementary current (I_{CTATY}) may include the ‘Tln(T)’ value, which is a logarithmic error, and may flow through the second resistor R2 by the base-emitter voltage VBE4. However, the size (e.g., value) of the ‘Tln(T)’ value included in the second temperature complementary current (I_{CTATY}) may be different from the size (e.g., value) of the ‘Tln(T)’ value included in the first temperature complementary current (I_{CTATX}). Therefore, it will be understood that the ‘Tln(T)’ value, which is a logarithmic error or a second-order coefficient based on temperature, may be eliminated by, e.g., adjusting the size ratio of the first temperature complementary current (I_{CTATX}) and the second temperature complementary current (I_{CTATY}).

Continuing with reference to FIG. 2, the temperature coefficient compensation circuit 150a may eliminate the ‘Tln(T)’ value, which is a logarithmic error, by using the temperature complementary currents (I_{CTATX}, I_{CTATY}) generated by the CTAT generator circuit 130a. The temperature coefficient compensation circuit 150a may then generate a curvature-compensated (e.g., flattened) reference voltage (Vref) from a reference current (Iref) from which the logarithmic error is removed. In some embodiments, the temperature coefficient compensation circuit 150a may include a first node N1, a second node N2, a first CTAT current source 151, a second CTAT current source 153, a PTAT current source 155, PMOS transistors PM5 and PM6, and a third resistor R3.

The first CTAT current source 151 may provide a second temperature complementary current (I_{CTATY}) from a power supply voltage VDD to the first node N1. The first CTAT current source 151 may be implemented through current mirroring of the second temperature complementary current (I_{CTATY}) generated by the second CTAT generator circuit 134a. The second CTAT current source 153 may supply an adjusted first temperature complementary current (e.g., the first temperature complementary current multiplied by a factor of K₁) (K₁I_{CTATX}). The second CTAT current source 153 may further discharge the adjusted first temperature complementary current from the first node N1 to ground. The second CTAT current source 153 may be implemented using a plurality of current mirrors that mirror the first temperature complementary current (I_{CTATX}) generated by the first CTAT generator circuit 132a. Accordingly, a third temperature complementary current (I_{CTATD}) corresponding, e.g., to the difference between the adjusted first temperature complementary current (K₁I_{CTATX}) and the second temperature complementary current (I_{CTATY}) may flow through the PMOS transistor PM5. Thus, the third temperature complementary current (I_{CTATD}) may have a value of ‘K₁I_{CTATX}−I_{CTATY}’, and the third temperature complementary current (I_{CTATD}) may be provided without the second-order coefficient for temperature (e.g., in a state where the ‘Tln(T)’ value corresponding to the second-order term for temperature is removed).

The PMOS transistor PM6 may include a current mirror circuit that adjusts the third temperature complementary current (I_{CTATD}) flowing in the PMOS transistor PM5, e.g., by multiplying the current by a factor of K₂. For example, the PMOS transistor PM6 may comprise K₂ parallel-connected transistors that share a gate with the PMOS transistor PM5. The temperature complementary current adjusted by the PMOS transistor PM6 (K₂I_{CTATD}) may be provided to the second node N2.

In addition, the PTAT current source 155 may supply the temperature proportional current (I_{PTAT}), to be combined with the adjusted third temperature complementary current (K₂I_{CTATD}) from the power supply voltage VDD, to the second node N2. The reference current (Iref) may be generated, e.g., as [I_{PTAT}+K₂I_{CTATD}=I_{PTAT}+K₂×(K₁I_{CTATX}−I_{CTATY})=I_{PTAT}+K₁K₂I_{CTATX}−K₂I_{CTATY}]. The reference voltage (Vref) may then be provided based on the reference current (Iref) generated and flowing through the third resistor R3.

According to the reference voltage generation circuit 100a described above and illustrated in FIG. 2, temperature complementary currents (I_{CTATX}, I_{CTATY}) each having ‘Tln(T)’ values (e.g., error terms) of different sizes may be generated by using a current mirror circuit and two BJTs Q3 and Q4. Through the combination of the temperature complementary currents (I_{CTATX} and I_{CTATY}), the third temperature complementary current (I_{CTATD}) may be generated with the ‘Tln(T)’ value (e.g., temperature error term) removed. Then, by combining the third temperature complementary current (I_{CTATD}) and the temperature proportional current (I_{PTAT}), as described above and elsewhere herein, a reference current (Iref) may be generated, from which a reference voltage (Vref) may be generated, wherein the generated reference voltage (Vref) has the first-order coefficient ‘T’ of the temperature and the second-order coefficient ‘Tln(T)’ removed.

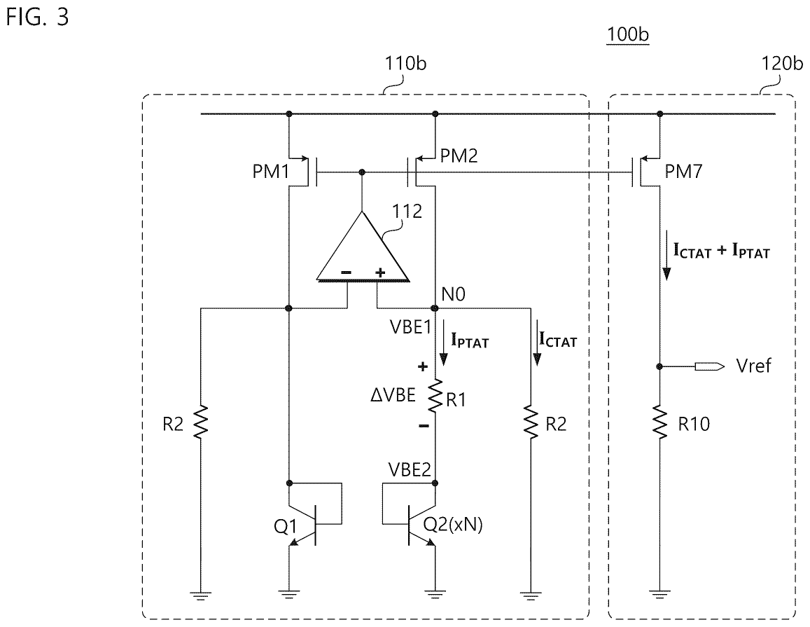

FIG. 3 is a circuit diagram illustrating an example of a related art reference voltage generator circuit 100b that generates a reference voltage using only a PTAT generator circuit (e.g., the PTAT generator circuit 110a of FIG. 2). Referring to FIG. 3, in the reference voltage generator circuit 100b, the temperature complementary current (I_{CTAT}) and the temperature proportional current (I_{PTAT}) generated from the PTAT generator circuit 110b may be combined to remove the first-order coefficient temperature term, which is a linear component. However, it is difficult to remove the second-order coefficient, ‘Tln(T)’, which is a logarithmic error term included in the base-emitter voltage VBE, particularly when using only the PTAT generator circuit 110b. Therefore, high-order temperature coefficient components, e.g., of the second-order or higher, may remain in the temperature-voltage curve. This feature will be explained further below.

As described above, the PTAT generator circuit 110b may include PMOS transistors PM1 and PM2, an operational amplifier 112, the first resistor R1, the second resistors R2, and BJTs Q1 and Q2 to generate a temperature proportional current (I_{PTAT}) that increases with temperature. A source of each of the PMOS transistors PM1 and PM2 may be connected to a power supply voltage (VDD). A gate of each of the PMOS transistors PM1 and PM2 may be connected to an output terminal of the operational amplifier 112. A drain of the PMOS transistor PM1 may be connected to a negative input terminal (−) of the operational amplifier 112, and a drain of the PMOS transistor PM2 may be connected to a positive input terminal (+) of the operational amplifier 112. A collector of a diode-connected first BJT Q1 may be connected to a drain of the PMOS transistor PM1, and the emitter of the diode-connected first BJT Q1 may be connected to ground. The emitter of the diode-connected second BJT Q2 may also be connected to ground. The first resistor R1 may be connected between the drain of the PMOS transistor PM2 and the collector of the second BJT Q2. It will be further understood that the second BJT Q2 may comprise any number (xN) of parallel-connected diode-connected BJTs.

The base-emitter voltage VBE1 of the first BJT Q1 may be input to the negative input terminal (−) of the operational amplifier 112. The base-emitter voltage VBE1 of the first BJT Q1 may also be fed back to the positive input terminal (+) of the operational amplifier 112 by the feedback of the operational amplifier 112. Therefore, the first resistor R1 may be provided with a differential voltage (ΔVBE=VBE1−VBE2) between the base-emitter voltage VBE1 of the first BJT Q1 and the base-emitter voltage VBE2 of the second BJT Q2. The base-emitter voltage VBE1 of the first BJT Q1 may have a temperature complementary CTAT characteristic that decreases as the temperature increases. In addition, a temperature proportional current (I_{PTAT}) having a temperature proportional characteristic may flow through the first resistor R1 due to the differential voltage (ΔVBE).

In addition, a temperature complementary current (I_{CTAT}) may flow through the second resistor R2, which may be connected between the node N0—to which the base-emitter voltage VBE1 of the first BJT Q1 is applied—and ground. For example, the base-emitter voltage VBE1 provided to the second resistor R2 may have a temperature complementary characteristic. Finally, the temperature complementary current (I_{CTAT}) may be generated by, e.g., adding the second resistor R2 to the node N0, where the base-emitter voltage VBE1 of the PTAT generator circuit 110b is formed.

In the reference voltage output terminal 120b, the sum of the temperature complementary current (I_{CTAT}) and the temperature proportional current (I_{PTAT}) generated by the PTAT generator circuit 110b may be mirrored to generate the reference voltage (Vref). The sum current (I_{PTAT}+I_{CTAT}) flowing in the channel of the PMOS transistor PM2 may be mirrored by the PMOS transistor PM7 and supplied to the output resistor R10. Then, the reference voltage (Vref) without the first-order coefficient (or component) may be output to the output resistor R10.

The above description may be organized into exemplary equations, as follows. The temperature proportional current (I_{PTAT}) flowing in the first resistor R1 and the temperature complementary current (I_{CTAT}) flowing in the second resistor R2, by the differential voltage ΔVBE, may be expressed by the following Equations 1a and 1b, respectively.

$${I}_{PTAT} = \frac{VBE 1 - VBE 2}{{R}_{1}} = \frac{Δ VBE}{{R}_{1}} = \frac{{V}_{T} ln N}{{R}_{1}} \qquad ( Equations 1 a \& 1 b )$$

$${I}_{CTAT} = \frac{VBE 1}{{R}_{2}}$$

In Equations 1a and 1b above, ‘N’ represents the number of parallel connections of the second BJT Q2, and ‘V_{T}’ represents the thermal voltage. The output reference voltage (Vref) may further be expressed as Equation 2 below.

$$Vref = {V}_{PTAT} + {V}_{CTAT} = ( {I}_{PTAT} + {I}_{CTAT} ) \times R 10 = \frac{R 10}{R 1} {V}_{T} ln ( N ) + \frac{R 10}{R 1} VBE 1 \qquad ( Equation 2 )$$

Additionally, the base-emitter voltage VBE may be derived from the Equation expressing the collector current ‘Ic’ of the BJT as in Equation 3 below.

$${I}_{C} = {I}_{S} ( {e}^{\frac{{V}_{BE}}{{V}_{T}}} - 1 ) \approx {I}_{S} {e}^{\frac{{V}_{BE}}{{V}_{T}}} \qquad ( Equation 3 )$$

$${I}_{S} = {C}_{1} {T}^{η} {e}^{\frac{- {E}_{G 0}}{k T}}$$

$${V}_{B E} = {V}_{T} ln ( \frac{{I}_{C}}{{I}_{S}} )$$

In Equation 3, ‘I_{S}’ is the saturation current, ‘η’ is the process parameter, and ‘C₁’ is a constant. And assuming that the collector current ‘Ic’ is in the form of an exponent of the temperature ‘T’ (I_{c}=D₁T^{δ}), the base-emitter voltage VBE may be expressed as Equation 4 below.

$${V}_{BE} {\vert}_{{I}_{C} = {D}_{1} {T}^{δ}} = {V}_{G 0} - {V}_{T} [ ln ( {C}_{1} ) - ln ( {D}_{1} ) ] - {V}_{T} ln ( T ) ( η - δ ) \qquad ( Equation 4 )$$

Here, ‘δ’ represents the order for the temperature ‘T’ at the collector current Ic. ‘C₁’ and ‘D₁’ are each constants. In particular, the thermal voltage ‘V_{T}’ may be expressed by Equation 5 below.

$${V}_{T} = \frac{k T}{q} \qquad ( Equation 5 )$$

In Equation 5, ‘k’ is the Boltzmann constant, ‘q’ is the charge of electrons, and ‘T’ is the absolute temperature. As illustrated in the Equation 5, the thermal voltage ‘V_{T}’ is expressed as a first-order expression of the temperature ‘T’. Therefore, the base-emitter voltage VBE of Equation 4 includes a constant term V_{GO} and a first-order expression (or value) of the temperature ‘−V_{T}[ln(C₁)−ln(D₁)]’, and a second-order or higher expression ‘−V_{T}[ln(T)(η−δ)’. The higher-order expression ‘−V_{T}[ln(T)(η−δ)’ of the second-order or higher may be referred to herein as the ‘Tln(T)’ expression or value.

Ultimately, the base-emitter voltage VBE generated only through the PTAT generator circuit 110b will include the ‘Tln(T)’ value corresponding to the logarithmic error (or a higher-order term error). In the temperature proportional current (I_{PTAT}) or the temperature complementary current (I_{CTAT}) generated using the PTAT generator circuit 110b, the constant term and the first-order term for the temperature ‘T’ dominate. However, when the temperature proportional current (I_{PTAT}) and temperature complementary current (I_{CTAT}) are combined, the reference voltage (Vref) will still have a curvature due to the ‘Tln(T)’ value.

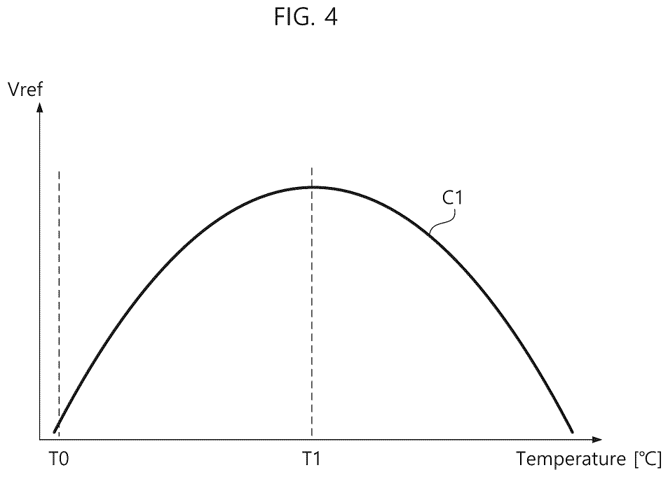

FIG. 4 is a graph illustrating an example of an unwanted change in the reference voltage with respect to temperature, as generated from the reference voltage generator circuit 100b of FIG. 3. Referring to FIG. 4, in the reference voltage curve C1 for temperature, a second-order curve shape for temperature ‘T’ is prominently illustrated as a result of the remaining ‘Tln(T)’ value.

A reference voltage Vref with the first-order component removed may be generated in the output resistor (e.g., R10 of FIG. 3) by the reference current Iref corresponding to the sum current (I_{PTAT}+I_{CTAT}) of the temperature complementary current (I_{CTAT}) and the temperature proportional current (I_{PTAT}) generated by the PTAT generator circuit (e.g., 110b of FIG. 3). According to the reference voltage curve C1, the reference voltage Vref exhibits relatively low stability, at least due to the ‘Tln(T)’ value. This is one exemplary reason why the removal of the ‘Tln(T)’ term may be beneficial in order to provide a reference voltage Vref that, e.g., maintains a stable level and is therefore more accurate with respect to changes in temperature (or with respect to extreme temperatures).

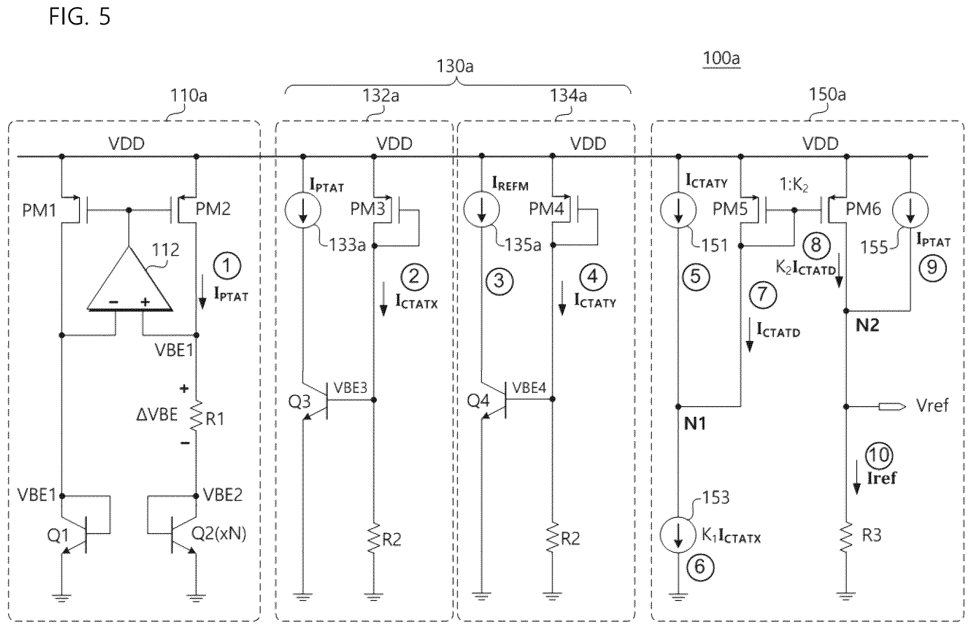

FIG. 5 is a circuit diagram illustrating an exemplary operation of a reference voltage generation circuit according to an embodiment of the present disclosure. Referring to FIG. 5, a temperature proportional current (I_{PTAT}) may be generated by a PTAT generator circuit 110a. Then, a first temperature complementary current (I_{CTATX}) and a second temperature complementary current (I_{CTATY}) may be generated based on the temperature proportional current (I_{PTAT}) by a CTAT generator circuit 130a. Then, by using the temperature complementary currents (I_{CTATX}, I_{CTATY}), a temperature coefficient compensation circuit 150a may generate a reference voltage Vref from which the logarithmic error ‘Tln(T)’ value (as well as the first-order error term) is removed. The procedure for removing a logarithmic error term from a reference current Iref by applying a curvature compensation technique will be described below with reference to additional Equations.

The PTAT generator circuit 110a may generate a temperature proportional current (I_{PTAT}) from the differential voltage (ΔVBE=VBE1−VBE2) applied to the first resistor R1. The differential voltage (ΔVBE=VBE1−VBE2) may correspond to the difference between the base-emitter voltage VBE1 of the first BJT Q1 and the base-emitter voltage VBE2 of the second BJT Q2. The base-emitter voltage VBE1 of the first BJT Q1 may have a temperature complementary CTAT characteristic that decreases as the temperature increases. Additionally, a temperature proportional current (I_{PTAT}) having a temperature proportional PTAT characteristic may flow through the first resistor R1 by the differential voltage (ΔVBE). If the temperature proportional current (I_{PTAT}) (marked as \textcircled{1} in FIG. 5) is expanded into a power series form with respect to the temperature ‘T’, it may be expressed by Equation 6 below.

$${I}_{PTAT} = \frac{Δ VBE}{R 1} = \frac{{V}_{T} ln ( N )}{R 1} = {C}_{PT 0} + {C}_{PT 1} T + {C}_{PT 2} {T}^{2} + ⋯ \qquad ( Equation 6 )$$

The first CTAT generator circuit 132a may mirror the temperature proportional current (I_{PTAT}) and provide it to the third BJT Q3. Since the temperature proportional current (I_{PTAT}) flows through the third BJT Q3, ‘8’ corresponding to the temperature-order of the temperature proportional current (I_{PTAT}) may be considered as having a value of ‘1’ (e.g., a first order). Based on such exemplary conditions, the first temperature complementary current (I_{CTATX}) (marked as \textcircled{2} in FIG. 5) generated by the first CTAT generator circuit 132a may be expressed by Equation 7 below.

$$\begin{matrix}{I}_{CTATX} = \frac{VBE 3 {\vert}_{{I}_{C 3} = {I}_{PTAT} = {D}_{1} {T}^{1}}}{R 2} \\ = \frac{{V}_{G 0} - {V}_{T} [ ln ( {C}_{1} ) - ln ( {D}_{1} ) ] - {V}_{T} ln ( T ) ( η - 1 )}{R 2} \\ = {C}_{CTX 0} - {C}_{CTX 1} T - {C}_{CTX 2} {T}^{2} - ⋯\end{matrix} \qquad ( Equation 7 )$$

Additionally, by combining the temperature proportional current (I_{PTAT}) and the first temperature complementary current (I_{CTATX}), an intermediate reference current (I_{REFM}) that is invariant with respect to temperature may be generated. In other words, the intermediate reference current (I_{REFM}) does not vary with temperature. Therefore, when the intermediate reference current (I_{REFM}) (marked as \textcircled{3} in FIG. 5) is provided to the fourth BJT Q4, the temperature-order ‘8’ may be considered as having a value of ‘0’. In such an exemplary case, the second temperature complementary current (I_{CTATY}) (marked as \textcircled{4} in FIG. 5) may be expressed by Equation 8 below.

$$\begin{matrix}{I}_{CTATY} = \frac{{V}_{B E 4} {\vert}_{{I}_{C 4} = {I}_{REFM} = {D}_{2} {T}^{0}}}{R 2} \\ = \frac{{V}_{G 0} - {V}_{T} [ ln ( {C}_{1} ) - ln ( {D}_{2} ) ] - {V}_{T} ln ( T ) ( η - 0 )}{R 2} \\ = {C}_{C T Y 0} - {C}_{C T Y 1} T - {C}_{C T Y 2} {T}^{2} - ⋯\end{matrix} \qquad ( Equation 8 )$$

Considering Equations 7 and 8 together, when currents based on the temperature proportional current (I_{PTAT}) are applied to different BJTs Q3 and Q4, temperature complementary currents (I_{CTATX}, I_{CTATY}) having different logarithmic errors ‘Tln(T)’ of the second order of ‘T’ may be generated. Accordingly, by adjusting the ratio or size of the coefficients (C_{CTX2}, C_{CTY2}) of the second-order terms of the first temperature complementary current (I_{CTATX}) and the second temperature complementary current (I_{CTATY}), it may be possible to remove the logarithmic error of the second-order term for temperature, e.g., the ‘Tln(T)’ value, in a combined reference current.

In order to remove the second-order term, ‘Tln(T)’, the first CTAT current source 151 of the temperature coefficient compensation circuit 150a may provide the second temperature complementary current (I_{CTATY}) from the power supply voltage VDD to the first node N1 (marked as \textcircled{5} in FIG. 5). The second CTAT current source 153 may discharge the first temperature complementary current (I_{CTATX}), adjusted ‘K₁’ times (e.g., multiplied by a factor of K₁), from the first node N1 to ground (marked as \textcircled{6} in FIG. 5). Therefore, a third temperature complementary current (I_{CTATD}), which may be equal to the difference between the first temperature complementary current (K₁I_{CTATX}) and the second temperature complementary current (I_{CTATY}), may flow through the PMOS transistor PM5 (marked as \textcircled{7} in FIG. 5). The third temperature complementary current (I_{CTATD}) may be expressed by Equation 9 below.

$$\begin{matrix}{I}_{CTATD} = {K}_{1} {I}_{CTATX} - {I}_{CTATY} \\ = ( {K}_{1} {C}_{CTX 0} - {C}_{CTY 0} ) + ( {K}_{1} {C}_{CTX 1} - {C}_{CTY 1} ) T + ( 0 ) {T}^{2} + ⋯\end{matrix} \qquad ( Equation 9 )$$

As exemplified by Equation 9 above, the third temperature complementary current (I_{CTATD}) may confirm that the second-order term of the temperature ‘T’ has been removed (e.g., made to have a value of ‘0’ based on the combination of the first temperature complementary current (K₁I_{CTATX}) and the second temperature complementary current (I_{CTATY}). Therefore, only a constant term and a first-order term for the temperature ‘T’ may remain in the third temperature complementary current (I_{CTATD}).

The third temperature complementary current (I_{CTATD}), now with the second-order term of the temperature ‘T’ removed, may be mirrored through the PMOS transistor PM6 for combination with the temperature proportional current (I_{PTAT}). The PMOS transistor PM6 may include a current mirror circuit that adjusts the third temperature complementary current (I_{CTATD}), flowing through the PMOS transistor PM5, by a factor of ‘K₂’ (e.g., the third temperature complementary current (I_{CTATD}) multiplied by a factor of K₂). The third temperature complementary current, as adjusted by the PMOS transistor PM6 (K₂I_{CTATD}), may be provided to the second node N2 (marked as \textcircled{8} in FIG. 5).

In addition, the PTAT current source 155 may supply the temperature proportional current (I_{PTAT}), from the power supply voltage VDD to the second node N2, to be combined with the adjusted third temperature complementary current (K₂I_{CTATD}) (marked as \textcircled{9} in FIG. 5). The sum of the temperature proportional current (I_{PTAT}) and the adjusted third temperature complementary current (K₂I_{CTATD}) may provide the reference current Iref. The reference current Iref may be expressed by Equation 10 below.

$$\begin{matrix}{I}_{ref} = {I}_{PTAT} + {K}_{2} {I}_{CTATD} \\ = ( {C}_{PT 0} + {K}_{1} {K}_{2} {C}_{CTX 0} - {K}_{2} {C}_{CTY 0} ) + ( 0 ) T + ( 0 ) {T}^{2} + ⋯\end{matrix} \qquad ( Equation 10 )$$

As illustrated in Equation 10 above, the first-order and second-order terms of the temperature ‘T’ may be removed from the reference current Iref calculation. Accordingly, the stability of the reference current Iref with respect to temperature may be improved. The reference current Iref may be output as the reference voltage Vref exhibited by, e.g., the third resistor R3 (marked as \textcircled{10} in FIG. 5). It will be understood that, in FIG. 5, the numbers do not indicate any absolute order of the exemplary operations illustrated, and the order may change depending on the conditions.

The reference voltage Vref based on the reference current Iref may be expressed by Equation 11 below.

$${V}_{r e f} = R 3 \times {I}_{r e f} \qquad ( Equation 11 )$$

As exemplified in Equation 11 above, the reference voltage Vref, from which the first-order and second-order terms of the temperature ‘T’ have been removed, may be provided through, e.g., the reference voltage generation circuit 100a of FIG. 5.

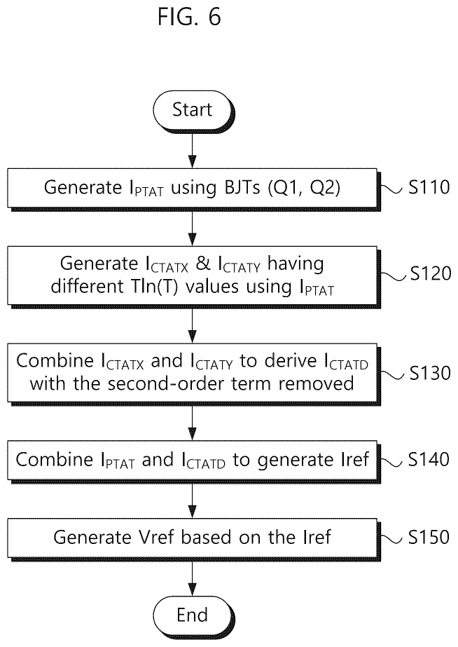

FIG. 6 is a flowchart illustrating a reference voltage generation method according to an embodiment of the present disclosure. Referring to FIG. 6, a reference voltage generation circuit (e.g., reference voltage generation circuit 100a of FIG. 5) may generate a third temperature complementary current (I_{CTATD}), from which a ‘Tln(T)’ value is removed, by, e.g., using two BJTs (e.g., BJTs Q3 and Q4 of FIG. 5) in a CTAT generator circuit (e.g., CTAT generator circuit 130a of FIG. 5). The reference voltage generation circuit may generate a reference voltage Vref having high temperature stability based on the third temperature complementary current (I_{CTATD}).

In operation S110, a PTAT generator circuit (e.g., PTAT generator circuit 110a of FIG. 5) may generate a temperature proportional current (I_{PTAT}) from a differential voltage (ΔVBE=VBE1−VBE2) applied to a first resistor (e.g., first resistor R1 of FIG. 5). The differential voltage (ΔVBE=VBE1−VBE2) may correspond, e.g., to the difference between the base-emitter voltage VBE1 of a first BJT (e.g., the first BJT Q1 of FIG. 5) and the base-emitter voltage VBE2 of a second BJT (e.g., the second BJT Q2 of FIG. 5). The base-emitter voltage VBE1 of the first BJT may have a temperature complementary CTAT characteristic that decreases as the temperature increases. Additionally, a temperature proportional current (I_{PTAT}) having a temperature proportional PTAT characteristic may flow through the first resistor due to the differential voltage.

In operation S120, the CTAT generator circuit (e.g., CTAT generator circuit 130a of FIG. 5) may mirror the temperature proportional current (I_{PTAT}) generated by the PTAT generator circuit to generate the first temperature complementary current (I_{CTATX}) and the second temperature complementary current (I_{CTATY}). The first temperature complementary current (I_{CTATX}) may be generated by applying the temperature proportional current (I_{PTAT}) to a third BJT (e.g., the third BJT Q3 of FIG. 5). The second temperature complementary current (I_{CTATY}) may be generated by supplying an intermediate reference current (I_{REFM}) to a fourth BJT (e.g., the fourth BJT Q4 of FIG. 5). For example, by combining the temperature proportional characteristic of the temperature proportional current (I_{PTAT}) and the temperature complementary characteristic of the first temperature complementary current (I_{CTATX}), a flattened intermediate reference current (I_{REFM}) with respect to temperature may be derived. Each of the first temperature complementary current (I_{CTATX}) and the second temperature complementary current (I_{CTATY}), however, may further include a logarithmic error term, ‘Tln(T)’.

In operation S130, the temperature coefficient compensation circuit (e.g., temperature coefficient compensation circuit 150a of FIG. 5) may generate a third temperature complementary current (I_{CTATD}) that has only a constant term and a first-order term for temperature by combining an adjusted first temperature complementary current (K₁I_{CTATX}) and the second temperature complementary current (I_{CTATY}). This process is described with reference to Equation 9 above and elsewhere herein.

In operation S140, the temperature coefficient compensation circuit may generate a reference current Iref by combining the temperature proportional current (I_{PTAT}) and an adjusted third temperature complementary current (K₂I_{CTATD}). The sum of the adjusted third temperature complementary current (K₂I_{CTATD}) and the temperature proportional current (I_{PTAT}) may be calculated as the reference current Iref (e.g., [I_{PTAT}+K₂I_{CTATD}=I_{PTAT}+K₂(K₁I_{CTATX}−I_{CTATY})]).

In operation S150, the temperature coefficient compensation circuit may generate a reference voltage Vref based on the reference current Iref, from which both the first-order term and the second-order term of the temperature ‘T’ have been removed.

As described above, the reference voltage generation circuit (e.g., reference voltage generation circuit 100a of FIG. 5) may generate the reference voltage Vref from which the first-order term and the second order term for the temperature ‘T’ are removed, e.g., by using two BJTs (e.g., Q3 and Q4 of FIG. 5).

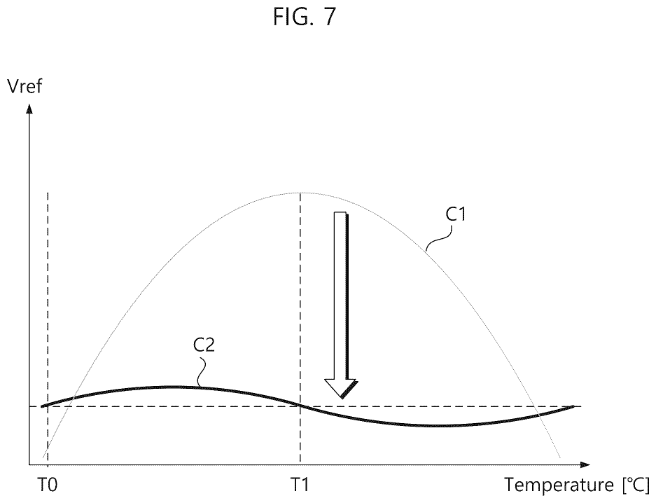

FIG. 7 is a graph illustrating an exemplary reference voltage whose curvature is compensated by a reference voltage generation circuit consistent with disclosed embodiments. Referring to FIG. 7, a reference voltage generation circuit (e.g., reference voltage generation circuit 100a of FIG. 5) may provide a reference voltage Vref from which the first-order term and the second-order term for the temperature ‘T’ are removed.

In FIG. 7, curve C2 shows the reference voltage Vref with the first-order and second-order terms for temperature ‘T’ removed (e.g., a reference voltage Vref without the first-order coefficient for temperature or the second-order coefficient for temperature). According to curve C2, the reference voltage Vref may be flattened to an extent that it is nearly parallel to the temperature axis. In addition, it may be seen that the reference voltage Vref fluctuation range based on temperature change is significantly reduced as compared with curve C1 (corresponding to the graph of FIG. 4) where, e.g., the second-order curve shape for temperature ‘T’ is greater. While a temperature coefficient term associated with a third-order (or a higher-order) may exist slightly in curve C2, the overall degree of fluctuation of the reference voltage Vref is significantly reduced, and such a slight degree does not significantly affect the temperature stability. In fact, the temperature coefficient illustrated in the reference voltage Vref of curve C2 is found to be reduced by more than 10 times compared to the temperature coefficient of curve C1.

As described above, a reference voltage Vref with the ‘Tln(T)’ value removed may be generated by adding two BJTs (e.g., Q3 and Q4 of FIG. 5). Therefore, according to the present disclosure, a reference voltage generation circuit that provides a reference voltage Vref with high temperature stability at low cost may be implemented.

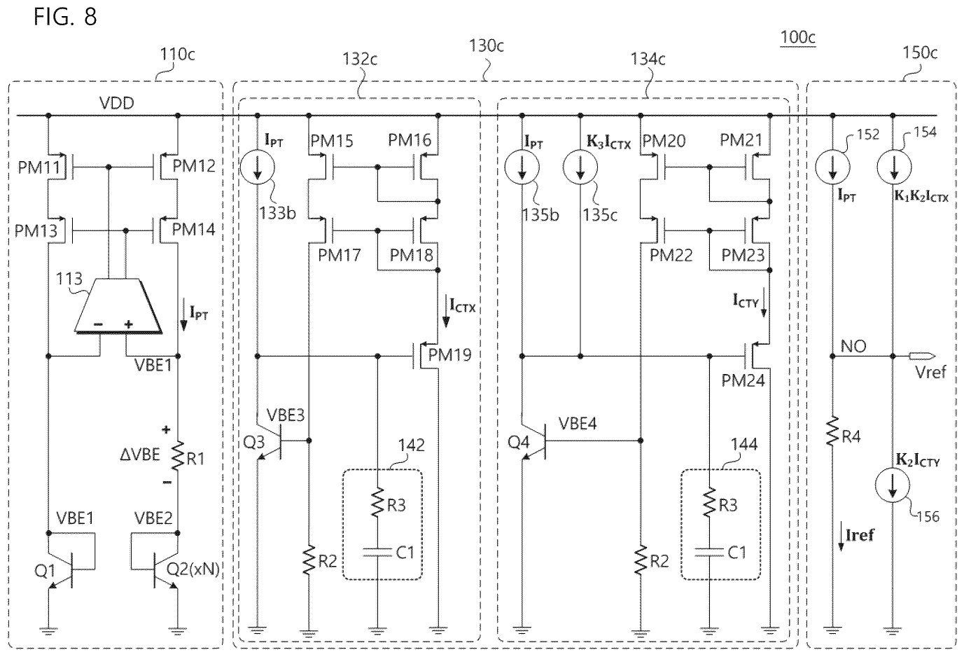

FIG. 8 is a circuit diagram illustrating another embodiment of a reference voltage generation circuit (e.g., the reference voltage generation circuit of FIG. 1). Referring to FIG. 8, the reference voltage generation circuit 100c includes a PTAT generator circuit 110c, a CTAT generator circuit 130c, and a temperature coefficient compensation circuit 150c. In this embodiment, the CTAT generator circuit 130c further includes stabilization circuits 142 and 144.

The PTAT generator circuit 110c may include PMOS transistors PM11, PM12, PM13 and PM14, an operational amplifier 113, a first resistor R1, and BJTs Q1 and Q2 to generate a temperature proportional current (IPT) that increases with temperature. The source of each of the PMOS transistors PM11 and PM12 sharing the gate may be connected to a power supply voltage VDD. Likewise, the sources of PMOS transistors PM13 and PM14 sharing the gate may be connected to the drains of PMOS transistors PM11 and PM12. The operational amplifier 113 may have two output terminals connected to the shared gate of PMOS transistors PM11 and PM12 and the shared gate of PMOS transistors PM13 and PM14. The drain of PMOS transistor PM13 may be connected to the negative input terminal (−) of operational amplifier 113, and the drain of PMOS transistor PM14 may be connected to the positive input terminal (+) of operational amplifier 113.

The collector of the diode-connected first BJT Q1 may be connected to the drain of PMOS transistor PM13. The emitter of the diode-connected first BJT Q1 may be connected to ground GND. The emitter of the diode-connected second BJT Q2 may also be connected to ground GND. The first resistor R1 may be connected between the drain of the PMOS transistor PM14 and the collector of the second BJT Q2. In FIG. 8, the second BJT Q2 may be a number (xN) of parallel-connected diode-connected BJTs.

The base-emitter voltage VBE1 of the first BJT Q1 may be input to the negative input terminal (−) of the operational amplifier 113. And the base-emitter voltage VBE1 of the first BJT Q1 may be fed back to the positive input terminal (+) of the operational amplifier 113 by the feedback of the operational amplifier 113. Therefore, the first resistor R1 may be subjected to a differential voltage (ΔVBE=VBE1−VBE2) between the base-emitter voltage VBE1 of the first BJT Q1 and the base-emitter voltage VBE2 of the second BJT Q2. The base-emitter voltage VBE1 of the first BJT Q1 may have a temperature complementary characteristic that decreases as the temperature increases. Additionally, a temperature proportional current (IPT) having a temperature proportional characteristic may flow through the first resistor R1 by the differential voltage ΔVBE. For example, the basic operation of the PTAT generator circuit 110c may be based on the temperature complementary CTAT characteristic that is generated by using the base-emitter voltage VBE1 of the first BJT Q1.

The CTAT generator circuit 130c may generate a first temperature complementary current (I_{CTX}) and a second temperature complementary current (I_{CTY}) by mirroring the temperature proportional current (IPT) generated by the PTAT generator circuit 110c. To this end, the CTAT generator circuit 130c may include a first CTAT generator circuit 132c for generating the first temperature complementary current (I_{CTX}) and a second CTAT generator circuit 134c for generating the second temperature complementary current (I_{CTY}).

The first CTAT generator circuit 132c may include a PTAT current source 133b, a third BJT Q3, PMOS transistors PM15, PM16, PM17, PM18 and PM19, a second resistor R2, and the stabilization circuit 142. The PTAT current source 133b may use the temperature proportional current (I_{PT}) generated from the PTAT generator circuit 110c. The PTAT current source 133b supplying the temperature proportional current (I_{PT}) may be implemented by mirroring the temperature proportional current (I_{PT}) generated from the PTAT generator circuit 110c. The temperature proportional current (I_{PT}) may be delivered to the collector of the third BJT Q3. The emitter of the third BJT Q3 may be connected to ground and to the node between the drain of the PMOS transistor PM17 and the second resistor R2. Therefore, the base-emitter voltage VBE3 of the third BJT Q3, through which the temperature proportional current (I_{PT}) flows, may be applied to the second resistor R2. As a result, the first temperature complementary current (I_{CTX}) may flow through the second resistor R2. The collector voltage of the third BJT Q3 may be provided to the gate of the PMOS transistor PM19. The PMOS transistors PM15, PM16, PM17 and PM18 may form a current mirror circuit of the first temperature complementary current (I_{CTX}) flowing in the second resistor R2. Therefore, the first temperature complementary current (I_{CTX}) may flow in the channel of the PMOS transistor PM19. In some embodiments, a stabilization circuit 142, in which a capacitor C1 and a third resistor R3 are connected in series, may be connected between the gate of the PMOS transistor PM19 and ground to, e.g., stabilize the gate voltage of the PMOS transistor PM19.

The second CTAT generator circuit 134c may include a PTAT current source 135b, an adjusted CTAT current source 135c, a fourth BJT Q4, PMOS transistors PM20, PM21, PM22, PM23 and PM24, a second resistor R2, and the stabilization circuit 144. The PTAT current source 135b may use a temperature proportional current (I_{PT}) generated from the PTAT generator circuit 110c. The temperature proportional current (I_{PT}) may be delivered to the collector of the fourth BJT Q4. The adjusted CTAT current source 135c may adjust the first temperature complementary current (I_{CTX}) generated from the first CTAT generator circuit 132c (e.g., by multiplying it by a factor of ‘K₃’) and may provide the adjusted current to the collector of the fourth BJT Q4. The emitter of the fourth BJT Q4 may be connected to ground and to the node between the drain of the PMOS transistor PM22 and the second resistor R2. Therefore, the intermediate reference current (e.g., I_{PT}+K₃×I_{CTX}) may flow through the fourth BJT Q4.

Additionally, the base-emitter voltage VBE4 of the fourth BJT Q4, through which the intermediate reference current (e.g., I_{PT}+K₃×I_{CTX}) flows, may be applied to the second resistor R2. Therefore, the second temperature complementary current (I_{CTY}) may flow through the second resistor R2. And the collector voltage of the fourth BJT Q4 may be provided to the gate of the PMOS transistor PM24. The PMOS transistors PM20, PM21, PM22 and PM23 may include a current mirror circuit for the second temperature complementary current (I_{CTY}) flowing through the second resistor R2. Accordingly, the second temperature complementary current (I_{CTY}) may flow in the channel of the PMOS transistors PM24. In addition, the stabilization circuit 144, including a capacitor C1 and a third resistor R3 connected in series, may be connected between the gate of the PMOS transistor PM24 and ground to, e.g., stabilize the gate voltage of the PMOS transistor PM24. The second temperature complementary current (I_{CTY}), including a ‘Tln(T)’ value, which is a logarithmic error, may flow in the second resistor R2 by the base-emitter voltage VBE4. However, the size of the ‘Tln(T)’ value included in the second temperature complementary current (I_{CTY}) may be different from the size of the ‘Tln(T)’ value of the first temperature complementary current (I_{CTX}). Therefore, by adjusting the size ratio of the first temperature complementary current (I_{CTX}) and the second temperature complementary current (I_{CTY}), it is possible to remove the logarithmic error (e.g., the second-order coefficient ‘Tln(T)’).

In some embodiments, the temperature coefficient compensation circuit 150c may generate a reference current Iref without the ‘Tln(T)’ term using the temperature proportional current (I_{PT}) generated from the PTAT generator circuit 110c and the temperature complementary currents (I_{CTX}, I_{CTY}) generated from the CTAT generator circuit 130c. The temperature coefficient compensation circuit 150c may generate a curvature-compensated reference voltage Vref from the reference current Iref from which the logarithmic error term is removed. For this purpose, the temperature coefficient compensation circuit 150c may include a PTAT current source 152, a first CTAT current source 154, a second CTAT current source 156, and a fourth resistor R4.

The PTAT current source 152 may generate the temperature proportional current (I_{PT}) generated from the PTAT generator circuit 110c in a mirroring manner. The PTAT current source 152 may generate the temperature proportional current (I_{PT}) and supply it to the output node NO. The first CTAT current source 154 may adjust the first temperature complementary current (I_{CTX}) generated from the first CTAT generator circuit 132c by ‘K₁×K₂’ and supply it to the output node NO. Therefore, the current, ‘I_{PT}+K₁K₂I_{CTX}’, with the ‘Tln(T)’ value removed, may be supplied to the output node NO. The second CTAT current source 156 may generate the second temperature complementary current (I_{CTX}) generated by the second CTAT generator circuit 134c by, e.g., multiplying it by a factor of K₂. Then, the second CTAT current source 156 may discharge the second temperature complementary current (I_{CTY}), as adjusted ‘K₂’ times, from the output node NO to ground. Therefore, the size of the reference current Iref supplied to the fourth resistor R4 may be expressed as ‘I_{PT}+K₁K₂I_{CTX}−K₂I_{CTX}’. As a result, the first- and second-order terms for temperature may be removed from the reference current Iref. The reference voltage Vref may be supplied to the output node NO based on the reference current Iref supplied to the fourth resistor R4.

According to the reference voltage generation circuit 100c described above, temperature complementary currents (I_{CTX}, I_{CTY}) having ‘Tln(T)’ values of different sizes may be generated by using a current mirror circuit and two BJTs (e.g., Q3 and Q4). The reference voltage Vref with the ‘Tln(T)’ value removed may be generated through a combination of the temperature complementary currents (I_{CTX}, I_{CTY}).

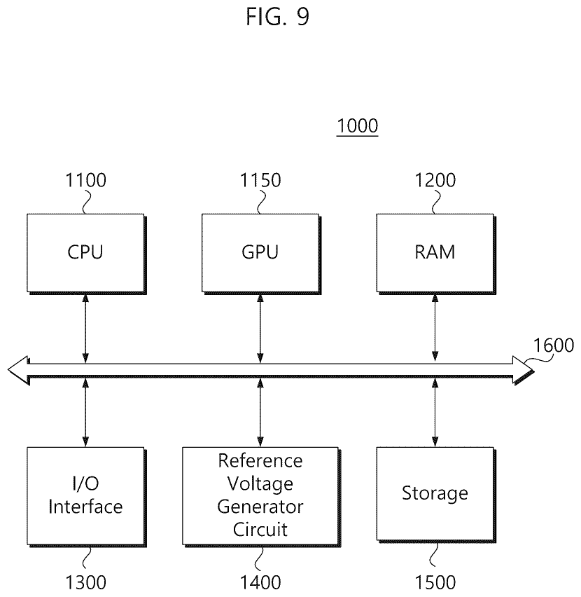

FIG. 9 is a block diagram illustrating a system-on-chip (SoC) including a reference voltage generator circuit consistent with disclosed embodiments. Referring to FIG. 9, the system-on-chip 1000 may include a central or core processing unit (CPU) 1100, a graphical processing unit (GPU) 1150, a Random-Access Memory (RAM) 1200, an input/output interface 1300, a reference voltage generator circuit 1400, a storage 1500, and a system bus 1600. As an example, the reference voltage generator circuit 1400 may be formed with the circuit structure illustrated in and described with reference to FIG. 2, 5, or 8.

The CPU 1100 may execute software (e.g., application programs, operating systems, device drivers) to be executed in the system-on-chip 1000. The CPU 1100 may execute an operating system (OS, not illustrated) loaded into the RAM 1200. The CPU 1100 may also execute various application programs that may be driven based on the operating system (OS).

The GPU 1150 may perform various graphic operations or parallel processing operations. In other words, the GPU 1150 may have an operation structure that is advantageous for parallel processing, e.g., that repeatedly processes similar operations. The GPU 1150 may also have a structure that may be used for various operations that require high-speed parallel processing as well as graphic operations. For example, a GPU 1150 that performs general-purpose tasks other than graphic processing may be referred to as a GPGPU (General Purpose computing on Graphics Processing Units). The use of GPGPUs has seen advantages in fields including but not limited to molecular structure analysis, password analysis, weather forecasting, and video encoding. Accordingly, it will be understood that the use of GPGPUs within disclosed embodiments may lead to similar advantages.

The operating system OS or application programs may be loaded into the RAM 1200. When the system-on-chip 1000 starts (e.g. boots), an OS image (not illustrated) stored in the storage 1500 may be loaded into the RAM 1200 based on the start (e.g. boot) sequence. The operating system OS may support various input/output operations of the system-on-chip 1000. Likewise, application programs selected by the user or those providing basic services may be loaded into the RAM 1200. The RAM 1200 may be a volatile memory such as SRAM (Static Random Access Memory) or DRAM (Dynamic Random Access Memory), or a non-volatile memory such as PRAM, MRAM, ReRAM, FRAM, or NOR flash memory.

The input/output interface 1300 may control user input and output from user interface devices. For example, the input/output interface 1300 may be equipped with a keyboard or a monitor configured to receive commands or data from the user. And the input/output interface 1300 may display the progress of learning or processing operations of the system-on-chip 1000, processing results, and other information.

As described above with respect to FIG. 2 and FIG. 8, the reference voltage generator circuit 1400 may generate a reference voltage Vref without the ‘Tln(T)’ value by, e.g., adding two BJTs Q3 and Q4. Therefore, according to the present disclosure, a reference voltage Vref with high temperature stability may be provided to the system-on-chip 1000 at a low cost.

The storage 1500 may be provided as a storage medium of the system-on-chip 1000. The storage 1500 may store application programs, operating system OS images, and other various data. The storage 1500 may also be provided as a memory card (e.g., MMC, eMMC, SD, MicroSD, etc.) or a hard disk drive HDD. The storage 1500 may include, e.g., a NAND-type flash memory having a large storage capacity. Alternatively, the storage 1500 may include a next-generation nonvolatile memory such as PRAM, MRAM, ReRAM, FRAM, or NOR Flash memory.

The system bus 1600 may provide a network within the system-on-chip 1000. Through the system bus 1600, the CPU 1100, the GPU 1150, the RAM 1200, the input/output interface 1300, the reference voltage generator circuit 1400, and the storage 1500 may be connected and may communicate or exchange data with each other. However, it will be understood that the configuration of the system bus 1600 is not limited to the above-described description, and may, e.g., further include mediation means for efficient management.

According to the above description, the system-on-chip 1000 may include the reference voltage generator circuit 1400 that generates a reference voltage Vref from which the ‘Tln(T)’ value is removed by, e.g., adding two BJTs. Therefore, according to these features, the system-on-chip 1000 of the present disclosure may implement high reliability by, e.g., using a reference voltage Vref having high temperature stability.

The above are specific embodiments for carrying out the present disclosure. In addition to the above-described embodiments, the present disclosure includes various design changes and variable embodiments not specifically described. In addition, the present disclosure includes techniques that may be modified and implemented variably using the specifically disclosed embodiments. Therefore, the scope of the present disclosure should not be limited to the above-described embodiments, and should be defined by the claims and equivalents of the claims of the present disclosure as well as the claims to be described later.

What is claimed is:

1. A reference voltage generation circuit for a semiconductor device, comprising:
a first current generator circuit configured to generate a temperature proportional current that increases in proportion to a temperature;
a second current generator circuit operatively coupled to the first current generator circuit and configured to generate a temperature complementary current that decreases as the temperature increases; and
a temperature coefficient compensation circuit operatively coupled to the first and second current generator circuits, wherein the temperature coefficient compensation circuit is configured to:
adjust the temperature proportional current or the temperature complementary current to alter a second-order coefficient for temperature associated with the temperature proportional current or the temperature complementary current; and
combine the temperature proportional current and the temperature complementary current, as adjusted, to generate a reference voltage without the second-order coefficient for temperature, the second-order coefficient for temperature being associated with a non-linear variation of the reference voltage.

2. The reference voltage generation circuit of claim 1, wherein the second current generator circuit comprises:
a first temperature complementary current generator circuit configured to:
supply the temperature proportional current to a first bipolar junction transistor; and
generate a first temperature complementary current using a base-emitter voltage of the first bipolar junction transistor; and
a second temperature complementary current generator circuit operatively coupled to the first temperature complementary current generator circuit and configured to:
generate an intermediate reference current by combining the temperature proportional current and the first temperature complementary current; and
apply the intermediate reference current to a second bipolar junction transistor to generate a second temperature complementary current.

3. The reference voltage generation circuit of claim 2, wherein the first temperature complementary current generator circuit comprises:
a first temperature proportional current source configured to mirror and supply the temperature proportional current;
the first bipolar junction transistor operatively coupled to the first temperature proportional current source and comprising a base, a collector coupled to the first temperature proportional current source, and an emitter connected to ground, wherein the first bipolar junction transistor is configured to transmit the temperature proportional current to ground;
a diode-connected first PMOS transistor operatively coupled to the first temperature proportional current source and the first bipolar junction transistor and configured to supply a power supply voltage to the base of the first bipolar junction transistor; and
a first resistor connected between the base of the first bipolar junction transistor and ground and configured to generate the first temperature complementary current based on the base-emitter voltage of the first bipolar junction transistor.

4. The reference voltage generation circuit of claim 3, wherein the second temperature complementary current generator circuit comprises:
a temperature-invariant current source configured to mirror and supply the intermediate reference current;
the second bipolar junction transistor operatively coupled to the temperature-invariant current source and comprising a base, a collector connected to the temperature-invariant current source, and an emitter connected to ground, wherein the second bipolar junction transistor is configured to transmit the intermediate reference current to ground;
a diode-connected second PMOS transistor operatively coupled to the temperature-invariant current source and the second bipolar junction transistor and configured to supply the power supply voltage to the base of the second bipolar junction transistor; and
a second resistor connected between the base of the second bipolar junction transistor and ground and configured to generate the second temperature complementary current based on the base-emitter voltage of the second bipolar junction transistor.

5. The reference voltage generation circuit of claim 2, wherein the temperature coefficient compensation circuit comprises:
a first node and a second node;
a first temperature complementary current source operatively coupled to the first node and configured to mirror and supply the second temperature complementary current to the first node;
a second temperature complementary current source operatively coupled to the first node and configured to supply an adjusted first temperature complementary current and discharge the adjusted first temperature complementary current from the first node to ground;
a first PMOS transistor operatively coupled to the first node and configured to supply a third temperature complementary current corresponding to a difference between the second temperature complementary current and the adjusted first temperature complementary current;
a second PMOS transistor operatively coupled to the first PMOS transistor and the second node and configured to mirror and supply an adjusted third temperature complementary current to the second node;
a temperature proportional current source operatively coupled to the second node and configured to mirror and supply the temperature proportional current to the second node; and
an output resistor connected between the second node and ground and configured to generate the reference voltage from a reference current, the reference current corresponding to a sum of the adjusted third temperature complementary current and the temperature proportional current.

6. The reference voltage generation circuit of claim 5, wherein the second PMOS transistor comprises K PMOS transistors connected in parallel and configured for adjusting the third temperature complementary current flowing in the first PMOS transistor K times.

7. The reference voltage generation circuit of claim 5, wherein the second-order coefficient for temperature is removed from the reference voltage based on the difference between the second temperature complementary current and the adjusted first temperature complementary current.

8. The reference voltage generation circuit of claim 5, wherein a first-order coefficient for temperature or the second-order coefficient for temperature is removed from the generated reference voltage based on a sum of the adjusted third temperature complementary current and the temperature proportional current.

9. A method for generating a reference voltage of a semiconductor device, the method comprising:
generating a temperature proportional current using a base-emitter voltage of a bipolar junction transistor;
generating, based on the temperature proportional current, a first temperature complementary current having a first second-order coefficient for temperature and a second temperature complementary current having a second second-order coefficient for temperature, wherein the first and second second-order coefficients have different values;
adjusting at least one of the first temperature complementary current or the second temperature complementary current;
generating a third temperature complementary current by combining the first temperature complementary current and the second temperature complementary current, as adjusted;
adjusting the third temperature complementary current; and
generating a reference current by combining the temperature proportional current and the adjusted third temperature complementary current.

10. The method of claim 9, wherein the first temperature complementary current and the second temperature complementary current are generated by supplying the temperature proportional current to different bipolar junction transistors, each of which generates a corresponding base-emitter voltage.

11. The method of claim 10, wherein the first temperature complementary current or the second temperature complementary current is further adjusted so that the first second-order coefficient for temperature and the second second-order coefficient for temperature have the same value.

12. The method of claim 11, wherein the temperature proportional current or the third temperature complementary current is further adjusted so that first-order coefficients for temperature, associated with the temperature proportional current and the third temperature complementary current, have the same value.

13. The method of claim 9, wherein the second temperature complementary current is generated using an intermediate reference current, wherein the intermediate reference current is generated by combining the temperature proportional current and the first temperature complementary current.

14. A reference voltage generation circuit for a semiconductor device, comprising:
a temperature proportional current generator circuit comprising a first bipolar junction transistor and a second bipolar junction transistor, the temperature proportional current generator circuit being configured to generate a temperature proportional current that increases in proportion to a temperature using the first bipolar junction transistor and the second bipolar junction transistor;
a temperature complementary current generator circuit operatively coupled to the temperature proportional current generator circuit and comprising a third bipolar junction transistor and a fourth bipolar junction transistor, the temperature complementary current generator circuit being configured to:
supply the temperature proportional current to the third bipolar junction transistor to generate a first temperature complementary current that decreases as the temperature increases;
generate an intermediate reference current by combining the temperature proportional current and the first temperature complementary current; and
generate a second temperature complementary current by applying the intermediate reference current to the fourth bipolar junction transistor; and
a temperature coefficient compensation circuit operatively coupled to the temperature proportional current generator circuit and the temperature complementary current generator circuit and configured to:
adjust at least one of the first temperature complementary current or the second temperature complementary current to alter a second-order coefficient for temperature; and
combine the first temperature complementary current and the second temperature complementary current, as adjusted, to generate a reference voltage without the second-order coefficient for temperature, the second-order coefficient for temperature being associated with a non-linear variation of the reference voltage.

15. The reference voltage generation circuit of claim 14, wherein the temperature complementary current generator circuit comprises:
a first temperature complementary current generator circuit configured to supply the temperature proportional current to the third bipolar junction transistor and generate the first temperature complementary current using a base-emitter voltage of the third bipolar junction transistor; and
a second temperature complementary current generator circuit operatively coupled to the first temperature complementary current generator circuit and configured to:
generate an intermediate reference current by combining the temperature proportional current and the first temperature complementary current; and
generate the second temperature complementary current by applying the intermediate reference current to the fourth bipolar junction transistor.

16. The reference voltage generation circuit of claim 15, wherein the first temperature complementary current generator circuit comprises:
a first temperature proportional current source configured to mirror and supply the temperature proportional current;
the third bipolar junction transistor operatively coupled to the first temperature proportional current source and comprising a base, a collector connected to the first temperature proportional current source to receive the temperature proportional current, and an emitter connected to ground;
at least one first PMOS transistor operatively coupled to the third bipolar junction transistor and configured to supply a power supply to the base of the third bipolar junction transistor;
a first resistor connected between the base of the third bipolar junction transistor and ground, wherein the first temperature complementary current is generated based on a base-emitter voltage of the third bipolar junction transistor;
at least one second PMOS transistor operatively coupled to the third bipolar junction transistor and configured to mirror the first temperature complementary current;
a third PMOS transistor connected between a drain of the at least one second PMOS transistor and ground and having a gate connected to the collector of the third bipolar junction transistor; and
a first stabilization circuit connected between the gate of the fourth PMOS transistor and ground.

17. The reference voltage generation circuit of claim 16, wherein the second temperature complementary current generator circuit comprises:
a second temperature proportional current source configured to mirror and supply the temperature proportional current to a first node;
a first temperature complementary current source configured to mirror and adjust the first temperature complementary current, and to supply the adjusted first temperature complementary current to the first node;
a fourth bipolar junction transistor operatively coupled to the first temperature complementary current source and comprising a base, a collector connected to the first node, and an emitter connected to ground, the fourth bipolar junction transistor being configured to receive the adjusted first temperature complementary current and the temperature proportional current;
at least one fifth PMOS transistor operatively connected to the fourth bipolar junction transistor and configured to supply the power supply to the base of the fourth bipolar junction transistor;
a second resistor connected between the base of the fourth bipolar junction transistor and ground, the second resistor being configured to generate a second temperature complementary current based on a base-emitter voltage of the fourth bipolar junction transistor;
at least one sixth PMOS transistor operatively coupled to the at least one fifth PMOS transistor and configured to mirror the second temperature complementary current;
a seventh PMOS transistor connected between a drain of the at least one sixth PMOS transistor and ground and having a gate connected to the collector of the fourth bipolar junction transistor; and
a second stabilization circuit connected between the gate of the seventh PMOS transistor and ground.

18. The reference voltage generation circuit of claim 17, wherein each of the first stabilization circuit and the second stabilization circuit comprises a capacitor and a third resistor connected in series.

19. The reference voltage generation circuit of claim 17, wherein the temperature coefficient compensation circuit comprises:
a third temperature proportional current source configured to supply the temperature proportional current to an output node;
a second temperature complementary current source operatively coupled to the output node and configured to mirror and adjust the first temperature complementary current and supply the adjusted first temperature complementary current to the output node;
a third temperature complementary current source operatively coupled to the output node and configured to mirror and adjust the second temperature complementary current and discharge the adjusted second temperature complementary current from the output node to ground; and
an output resistor connected between the output node and ground.

20. The reference voltage generation circuit of claim 19, wherein:
a reference current flows through the output resistor, the reference current corresponding to a sum of the temperature proportional current and the adjusted first temperature complementary current minus the adjusted second temperature complementary current, and
the first temperature complementary current and the second temperature complementary current are adjusted to remove the second-order coefficient for temperature from the reference current.
